(19) United States
(12) Patent Application Publication
(10) Pub. No.: US 2006/0226620 A1
(43) Pub. Date: Oct. 12, 2006

(54) Truck configuration for a skateboard, wheeled platform, or vehicle

(76) Inventor: Jeffrey E. Cole, Danville, CA (US)

Correspondence Address: BUCHANAN, INGERSOLL & ROONEY PC, POST OFFICE BOX 1404, ALEXANDRIA, VA, 22313-1404, US

(21) Appl. No.: 11/104,188

(22) Filed: Apr. 11, 2005

(51) Int. Cl. B62M 1/00

(52) U.S. Cl. 280/87.042

(57) ABSTRACT

A configuration for a wheeled platform or skateboard having a skateboard deck with an upper surface and a lower surface, the upper surface configured to receive at least one foot of a skater and the lower surface facing a riding surface; and a pair of trucks mounted on the upper surface of the skateboard deck.

### FIELD OF THE INVENTION

This invention generally relates to a truck configuration for a skateboard, a wheeled platform or a vehicle and more particularly to the configuration for a skateboard truck that is mounted to the top of the skateboard deck such that the truck's mounting location is located on the upper platform surface, which faces away from the ground surface.

### BACKGROUND OF INVENTION

The truck is an important element in the design of skateboards, wheeled platforms, roller skates, inline skates and vehicles. The truck not only supports the wheels of the skateboard, platform, inline skates, roller skates or vehicle, it may also provide the user with a significant degree of directional control. The trucks make it possible to control the direction of the skateboard, while the skater or skateboarder has both feet (can be one foot, as the other kicks) positioned on the deck and moves with the latter by rolling. The shifting of the skater's weight to one side or the other carries out the directional control of the skateboard.

Typically the trucks are mounted near each end of the skateboard, and include a wheel at each end of its axles. The trucks provide some steering response, whereby when a skateboarder shifts weight laterally across the board the axle twists, causing the board to turn.

In a typical skateboard truck, directional control is accomplished by providing the truck with four primary components: a truck hanger, a base plate, a kingpin, and bushings. Typically skateboard trucks (FIGS. 1 and 2) have two (2) axle extensions, which protrude laterally from the sides of the truck hanger upon which the skateboard wheels and bearings are mounted.

It can be appreciated that skateboard trucks come in a wide variety of construction and designs beyond the typical truck described herein. Each of these trucks designs tends to exhibit most, if not all, of the characteristics described below. Skateboard trucks are typically mounted below the skateboard deck in a front (or leading) and rear (or trailing) position along the longitudinal or lengthwise axis of the skateboard deck such that, at rest, the truck axle extensions at the leading position are roughly parallel to the truck axle extensions at the trailing position and all truck axle extensions are roughly perpendicular to the longitudinal axis of the skateboard deck when the skateboard is at rest. If this approximately parallel alignment of the trucks and their respective axles are maintained while the skateboard rolls along the ground, the skateboard's path will be relatively straight.

A skateboard truck is typically mounted on the side of the skateboard deck which faces the ground surface. For a given skateboard truck, which consists of a hanger and axles which do not extend beyond the edge of the skateboard deck, this mounting configuration is required for the proper operation of the skateboard. For a given skateboard truck, which consists of a hanger and axles which are sufficiently long enough to extend beyond the edge of the skateboard deck, it is possible to mount these trucks on the skateboard platform surface which faces away from the ground. This mounting configuration allows the use of larger diameter wheels for a given skateboard deck, while allowing the rider to maintain a lower center of gravity due to the deck's closer proximity to the ground surface. The wheel diameter will have to be sufficiently large enough to prevent the skateboard deck from scraping on the ground surface. The skateboard truck hangers and axles will have to be long enough to allow clearance between the edge of the larger wheels and the edge of the skateboard deck. This mounting configuration tends to allow the rider to maintain a lower and more stable center of gravity for a given skateboard deck while increasing the wheel diameter. Increasing the wheel diameter may provide for greater speeds and safer rides over obstacles and in off road conditions.

### SUMMARY OF THE INVENTION

In one aspect of the invention, a skateboard comprises a skateboard deck having an upper surface and a lower surface, the upper surface configured to receive at least one foot of a skater and the lower surface facing a riding surface; and a pair of trucks mounted on the upper surface of the skateboard deck.

In another aspect of the invention, a skateboard comprises a skateboard deck having an upper surface and a lower surface, the upper surface configured to receive at least one foot of a skater and the lower surface facing a riding surface; a pair of trucks mounted on the upper surface of the skateboard deck, wherein each of the trucks comprise at least one axle, wherein the at least one axle extends beyond an outer edge of the skateboard deck; and at least one wheel attached to the at least one axle.

In a further aspect of the invention, a method of mounting a truck to a platform comprises providing a platform having an upper surface and a lower surface, the upper surface configured to receive a skater; and mounting a truck configured to receive a pair of wheels.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 shows a perspective view of a skateboard.

FIG. 2 shows an exploded perspective view of a skateboard truck.

FIG. 3 shows an end view of a skateboard mounted with the truck of FIG. 2.

FIG. 4 shows a plan view of a skateboard.

FIG. 5 shows a side view of an alternative skateboard with a truck.

FIG. 6 shows an end view of the alternative truck of FIG. 5

FIG. 7 shows an end view of the truck of FIG. 3 mounted on the upper surface of the skateboard.

FIG. 8 shows a perspective view of the skateboard of FIG. 7.

FIG. 9 shows a side view of the truck of FIG. 5 and FIG. 6 mounted on the upper surface of a skateboard.

FIG. 10 shows perspective view of the skateboard of FIG. 9.

### DESCRIPTION OF THE INVENTION

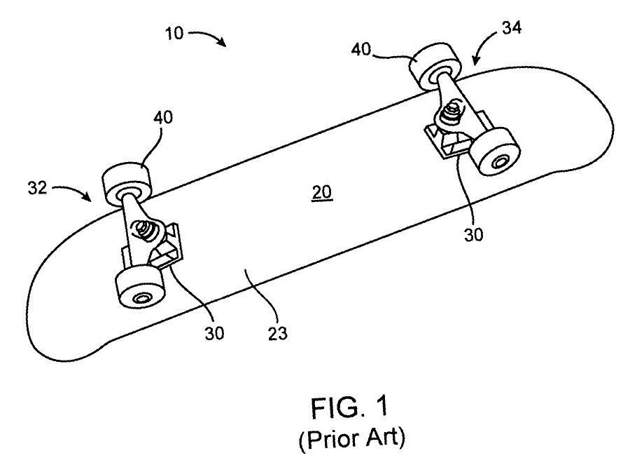

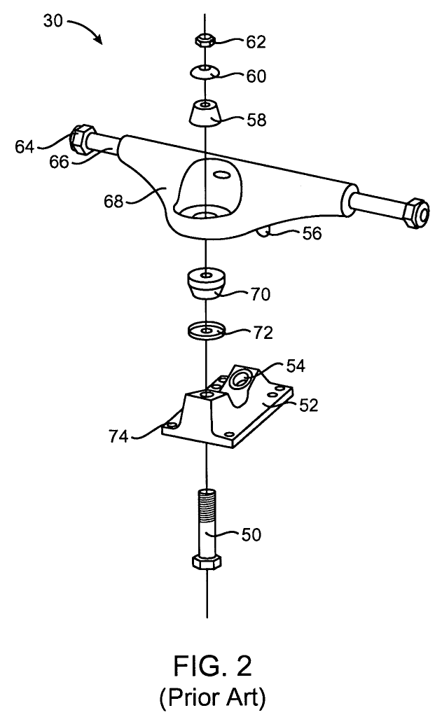

As shown in FIG. 1, a skateboard 10 typically comprises a deck 20, a pair of skateboard truck assemblies or trucks 30, and a plurality of wheels 40, most commonly four (4) wheels. Existing skateboard products have anywhere from 2 to 14 or more wheels. Skateboard trucks 30 made by various manufacturers vary significantly in design, but the most common designs (FIG. 2) typically have two (2) axle extensions 66, which protrude laterally from the sides of the truck 30 upon which the skateboard wheels 40 and bearings are mounted.

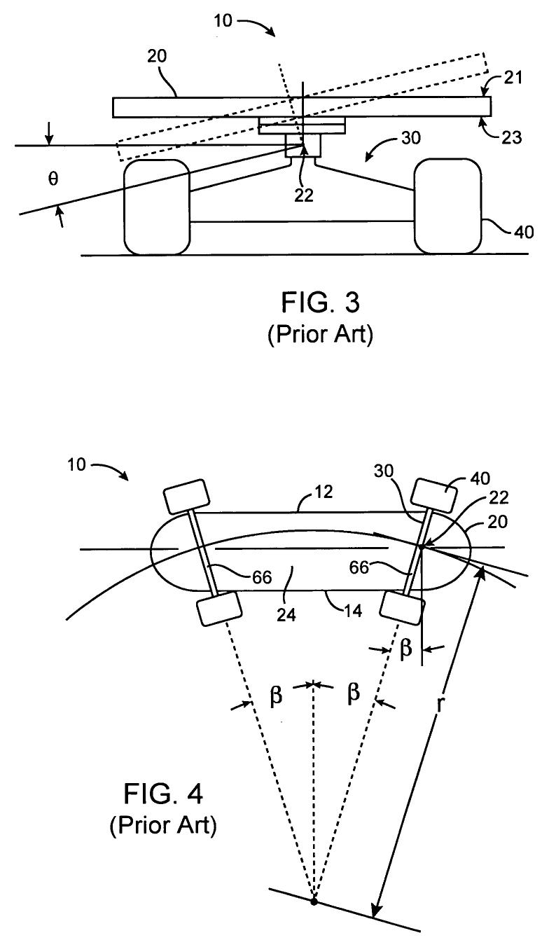

Skateboard truck assemblies or trucks 30 are typically mounted to a lower surface 23 of the skateboard deck 20 in a front 32 (or leading) and rear 34 (or trailing) position along the longitudinal or lengthwise axis of the skateboard deck 20 such that, at rest, the truck axle extensions 66 at the leading position 32 are roughly parallel to the truck axle extensions 66 at the trailing position 34 and all truck axle extensions 66 are roughly perpendicular to the longitudinal axis of the skateboard deck 20 when the skateboard 10 is at rest. If the approximately parallel alignment of the truck assembly 30 and their respective axles are maintained while the skateboard 10 rolls along the ground, the skateboard's path will be relatively straight. An upper surface 21 (as shown in FIG. 3) of the skateboard deck 20 forms a riding surface for the user of the skateboard 10. The upper surface 21 can include additional surface materials such as adhesive tapes with grips or other means of assisting the riders remain on the upper surface 21 of the skateboard deck 20 during the riding experience.

The skateboard deck 20 most commonly comprises a single piece of fiberglass, wood, wood laminates or wood composite or any suitable material for the skateboard deck 20. In addition, the deck 20 can have variable degrees of stiffness and flexibility based on the weight of the rider and the riders skateboarding style, i.e. gradual turns or a more aggressive pumping action of the skateboard deck 20. Some skateboard decks 20 consist of multiple pieces and/or are made from a combination of different materials.

The skateboard truck 30 most commonly comprises a multiple pieces of aluminum, steel, and/or other metals, and elastic components. Skateboard truck components can be constructed with any suitable material, including but not limited to fluids, gasses, plastics, rubber, metal, fabric, wood, electronics, etc.

FIG. 2 shows an exploded perspective view of a common style of skateboard truck 30. However, it can be appreciated that the embodiments described herein can be implemented with most any skateboard truck 30 and skateboard truck design.

As shown in FIG. 2, a common skateboard truck 30 comprises a kingpin 50, a base plate 52, a pivot cup 54, a pivot 56, an upper cushion (aka bushing) 58, an upper cushion washer 60, a kingnut 62, a pair of axle nuts 64, a hanger 68, axle extensions 66 which protrudes from two ends of the hanger 68, a bottom cushion (aka bushing) 70 and a bottom cushion washer 72.

The base plate 52 has a plurality of openings 74. The openings 74 are configured to each receive bolts (not shown) for attaching the base plate 52 of the truck 30 to the deck 20 of the skateboard 10. Each of the two axle extensions 66 can receive a wheel 40. The wheel 40 preferably includes bearings (not shown), and washers or spacers (not shown), which properly position the bearings and wheels 40 such that they can freely spin without rubbing against the hanger 68. The wheel 40 is secured to the axle extension 66 with an axle nut 64.

The plurality of wheels 40, are preferably skateboard wheels or suitable wheels preferably having bearings, which can be attached to the wheels and which fit over the axle extension 66 of the skateboard truck 30. The at least one axle extension 66 preferably protrudes from hanger 68 and is configured to receive a wheel 40. It can be appreciated that the skateboard 10 can be equipped with a hydraulic truck as shown in U.S. patent application Ser. No. 10/874,134, filed Jun. 21, 2004, which is incorporated herein in its entirety, in the front or rear of the skateboard and one standard truck at the opposite end of the skateboard. Alternatively, multiple hydraulic trucks can be mounted on the skateboard 10.

It can also be appreciated that the skateboard 10 can be equipped with a hydraulic truck as shown in U.S. patent application Ser. No. 11/051,088 filed Feb. 4, 2005, which is incorporated herein in its entirety, in the front or rear of the skateboard and one standard truck at the opposite end of the skateboard. Alternatively, multiple trucks as described in U.S. patent application Ser. No. 11/051,088 filed Feb. 4, 2005, can be mounted on the skateboard 10.

FIG. 3 shows an end view of a skateboard 10. As shown in FIG. 3, the weight of the skateboarder upon shifting his or her weight from side to side of the skateboard 10 causes the deck 20 of the skateboard to rotate about a pivot point 22, which is typically below the plane of the deck 20 of the skateboard 10. The pivot point 22 is typically located in the vicinity of the bushings 58, 70 of a common truck (FIG. 2). The pivot points 22 for a leading truck and a trailing truck are preferably each located on a plane which is perpendicular to the skateboard deck 20, and which also passes through the longitudinal axis of the skateboard deck 20. The axis of rotation of the skateboard deck 20 is defined by an imaginary line, which connects the two pivot points 22 on the leading and trailing trucks 30. It can be appreciated that the axis of rotation may not be so positioned without deviating from this invention. It can be appreciated that the position of the axis of rotation may dynamically shift in response to changes in orientation of the skateboard 10 without deviating from this invention.

FIG. 4 shows a bottom view of the skateboard 10 showing the skateboard's turning radius. As shown in FIG. 4, the turning path of the skateboard 10 will curve in the direction of the edge 14 of the skateboard that has been forced downwards. The greater the deck dipping angle, theta (θ), as seen in FIG. 3, of the skateboard deck 20 measured from its resting position and around the longitudinal axis connecting points 22, the greater the trucks' 30 turning angles, beta (β), from their resting parallel position, measured around a vertical axis passing through pivot points 22, and the shorter the turning radius, r, of the skateboard's path. When one edge 14 of the skateboard deck 20 is rotated downward by the deck dipping angle theta (θ), around the longitudinal axis connecting pivot points 22, the ends of the axle extensions 66 on that side of the skateboard 10 are caused to mechanically move towards one another, thus achieving the potential for the skateboard 10 to have a curved path.

As shown in FIG. 4, the skateboards path becomes curved when the axles 66 of the two trucks 30 are caused to have an alignment, which is no longer parallel to one another and no longer perpendicular to the longitudinal axis of the skateboard deck 20. The variable turning angle, beta (β), that the axle extension 66 of a truck 30 makes relative to its resting position (perpendicular to the longitudinal axis of the skateboard deck), is typically similar in magnitude, but opposite in direction, for each of the two trucks 30. It can be appreciated that the beta angle for the front and rear trucks 30 may be designed to be different from one another and/or in the same or opposite directions for a given dip angle, theta (θ), of the deck 20 without deviating from this invention.

The truck axle extensions 66 positions and alignment are designed to respond variably to different changes in the deck dipping angle, theta (θ), of the skateboard deck 20 from a first position to a second position. The path of the skateboard 10 will curve in the direction of the edge 14 of the skateboard deck 20 that has been forced downwards. The greater the deck dipping angle, theta (θ), of the skateboard deck 20, the greater the trucks' 30 turning angle, beta (β), from their resting position and the shorter the radius of curvature, r, of the skateboards 10 path.

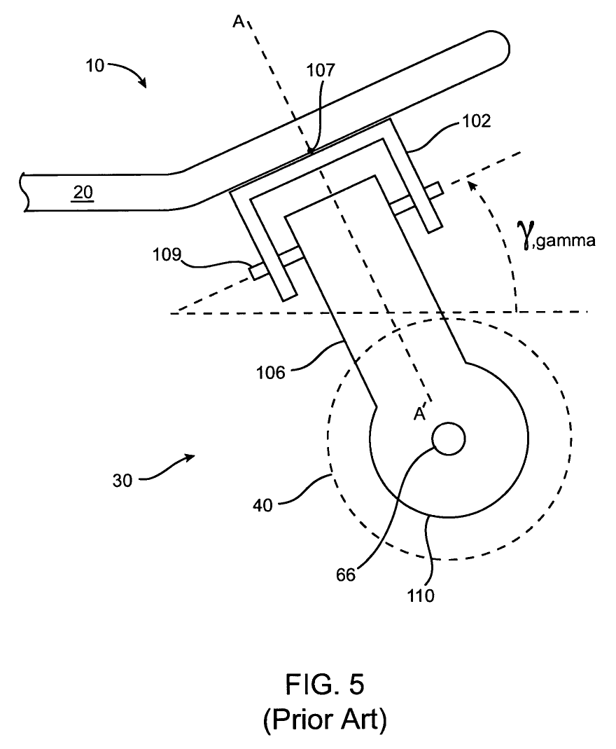

FIG. 5 shows a side view of one end of a skateboard 10 having an alternate truck assembly 30 comprising an inclined axial pivot point 109. The truck assembly 30 comprises a base plate bracket 102, a pivot member 106, an axle housing 110, and an axial pivot pin 109. It can be appreciated that truck assembly 30 designs based on this configuration can include other parts, including but not limited to fasters, washers, springs, and other suitable parts.

As shown in FIG. 5, the base plate bracket 102 can be configured to be attachable to the underside of the skateboard deck 20 with fasteners (not shown). The axle housing 110 includes a supporting structure or pivot member 106, which slips into and rotates within the base plate bracket 102. An axial pivot pin 109 connects the base plate bracket 102 to the pivot member 106 and allows the axle housing 110 to rotate around the axis of the axial pivot pin 109 as the rider dips the skateboard deck 20 from side to side. It can be appreciated that the axial pivot pin 109 can be fastened with washers, nuts, and other suitable components (not shown) to the base plate bracket 102.

The axial pivot pin 109 in FIG. 5 is configured to be inclined at an axial pin angle, gamma (γ), relative to the ground surface upon which the skateboard 10 is positioned. It is this angle, gamma (γ), which dictates the turning response angle, beta (β, as shown in FIG. 4), in response to the deck-dipping angle theta (θ, as shown in FIG. 5). The greater the axial pin angle, gamma (γ), the greater the turning response angle, beta (β), to any given deck dipping angle, theta (θ). If the axial pin angle, gamma (γ), is zero (0), then the turning response angle, beta (β), will be zero (0) in response to any given deck dipping angle, theta (θ). The axial pin angle, gamma (γ), may be positive or negative, thus creating the opportunity for unusual responses to the deck dipping angle, theta (θ).

Additionally, as shown in FIG. 5, the axial pin angle, gamma (γ), can be adapted to be adjustable (statically, or dynamically) to alter the turning characteristics of the skateboard 10. Because the skateboard wheels 40 tend to stay in contact with the riding surface due to the gravitational load of the rider, the axle housing 110 and attached structural pivot member 106 rotate around the axial pivot pin 109 in response to the rider dipping the deck 20 from left to right, theta (θ). Thus, when the rider dips the deck 20 left or right, theta (θ), the skateboard 10 has a turning response, beta (β), whose magnitude is defined by the axial pin angle, gamma (γ).

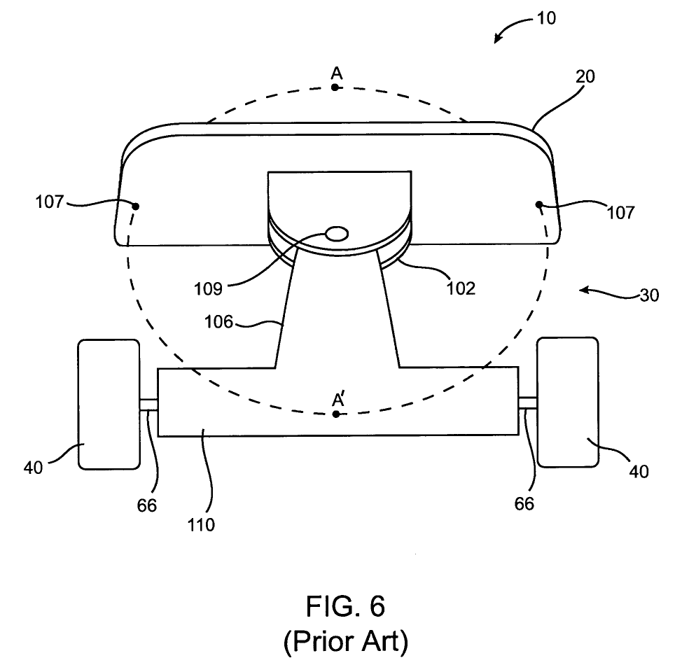

FIG. 6 shows an end view of the skateboard 10 and truck 30 of FIG. 5. As shown in FIG. 6, as the truck 30 rotates around the axial pivot point 109, a reference point A′ on the pivot member 106 moves in a concentric circle around the pivot point 109. The plane of the concentric circle of reference point A′ is perpendicular to the axis of the axial pivot pin 109 and therefore appears as an ellipse when drawn on the plane of the FIG. 6. The concentric circle maintains its axial alignment with that of the axial pivot pin 109 as the deck 10 is dipped left or right by any deck dipping angle, theta (θ), such that the plane formed by the concentric circle maintains the same angle, gamma (γ), when measured relative to the perpendicular to the ground surface. The concentric circle passes through a pair of intersection points 107 on the skateboard deck 20. As the skateboard deck 20 dips left and right through its deck dipping angle theta (θ, as shown in FIG. 3), the pivot member 106 and the truck housing 110 rotate in a concentric path around the axial pivot pin 109. The position of the concentric circle relative to the axial pivot pin 109 remains fixed and the position of the intersection points 107 remain fixed to the same spot on the skateboard deck 20.

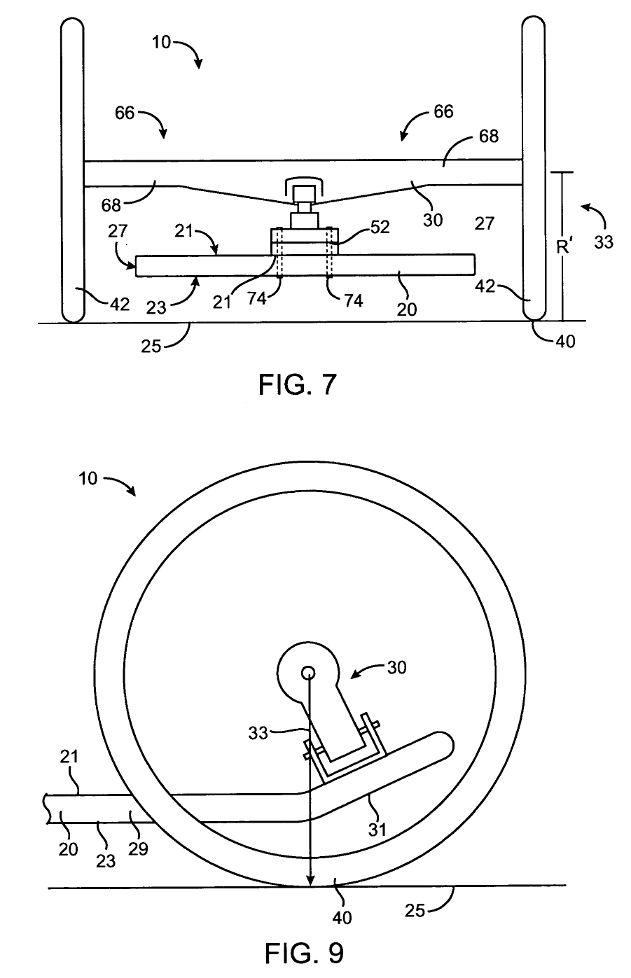

FIG. 7 shows an end view of the truck 30 of FIGS. 2 and 3 mounted on the same end of the skateboard deck 20, but on the deck's upper surface 21. As shown in FIG. 7, the skateboard deck 20 has an upper surface 21 and a lower surface 23. In this embodiment, the trucks 30 are mounted to the upper surface 21. The upper surface 21 is configured to receive a foot of a skater. The lower surface 23 or underside of the skateboard deck 20 is configured to face the ground or riding surface 25.

In operation, to maintain the proper turning characteristics, the orientation of the truck 30 of FIGS. 2 and 3 is preferably rotated by 180 degrees around the horizontal axis, which is parallel to the truck hanger 68 and truck axles 66 if mounted at the same end (trailing or leading) of the skateboard 10. As shown in FIG. 7, the wheels 40 have a larger diameter and maintain the distance of the deck 20 from the ground surface 25 as compared to that in FIG. 3. In addition, the length of the hanger 68 is increased to maintain proper clearance between an inner surface 42 of the wheels 40 and an outer surface 27 of the skateboard deck 20. The at least one wheel has an outer radius (R′) 33, wherein the outer radius 33 of the at least one wheel 40 is equal to at least a distance from the axle 66 to the ground or riding surface 25.

The base plate 52 of the truck preferably has a plurality of openings 74. The openings 74 are configured to each receive bolts (not shown) for attaching the base plate 52 of the truck 30 to the deck 20 of the skateboard 10. Each of the two axle extensions 66 can receive a wheel 40. The wheel 40 preferably includes bearings (not shown), and washers or spacers (not shown), which properly position the bearings and wheels 40 such that they can freely spin without rubbing against the hanger 68. The wheel 40 is secured to the axle extension 66 with an axle nut 64 (not shown).

FIG. 8 shows a perspective view of a skateboard 10 including the mounting configuration as shown in FIG. 7. As shown in FIG. 8, the trucks 30 are mounted onto the upper surface 21 of the skateboard deck 20. The upper surface 21 is configured to provide a riding surface for the user of the skateboard 10. The lower surface 23 of the skateboard deck 20 faces the ground surface 25. As shown in FIG. 8, the trucks 30 are mounted onto the upper surface 21 of the skateboard deck 20 with the kingpins 50 are facing outward or away from the inner portion 29 of the skateboard deck 20. As a result of the truck 30 being mounted on the upper surface 21 of the skateboard deck 20, the trucks 30 are rotated 180 degrees from the configuration as shown in FIG. 1, wherein the trucks 30 are mounted on the lower surface of the skateboard deck 20.

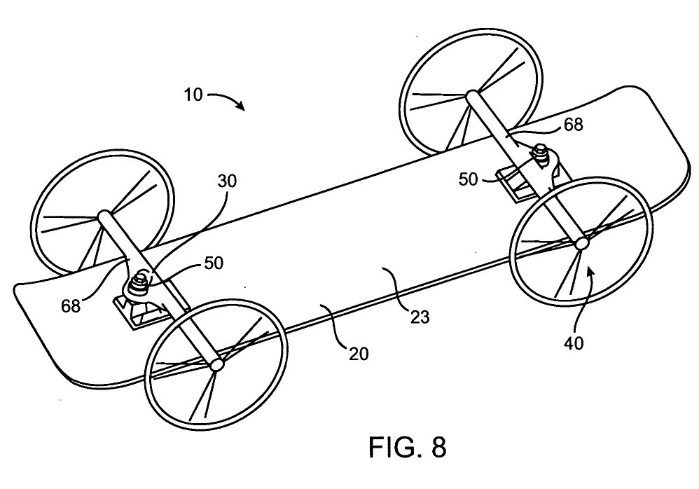

FIG. 9 shows a side-view of the truck 30 of FIG. 5 and FIG. 6 mounted on the same end of the skateboard deck 20, but on the deck's upper surface 21. To maintain the proper turning characteristics the orientation of the truck 30 of FIGS. 2 and 3 may or may not need to be rotated by 180 degrees around the horizontal axis, which is parallel to the truck hanger 68 and truck axles 66 if mounted at the same end (trailing or leading) of the skateboard 10. As shown in FIG. 9, the wheels 40 have a larger diameter and maintain the distance of the deck 20 from the ground or riding surface 25 as compared to the skateboard 10 as shown in FIGS. 5 and 6. In addition, the length of the hanger 68 is preferably increased to maintain proper clearance between the inner surface 41 of the wheels 40 and the skateboard deck 20.

In one embodiment, as shown in FIG. 9, the skateboard deck 20 has an inner portion 29, which is relatively horizontal to the riding surface 25. The truck 30 is attachable to an outer or tail portion 31 positioned on at least one end of the skateboard deck 20, wherein the outer portion 31 is at an angle relative to the riding surface 25 forming a flared tail. It can be appreciated that in an alternative embodiment, the skateboard deck 20 can be a relatively horizontal surface and the base plate 52 of the truck 30 can be designed with an inherent angle. The inherent angle of the base plate is configured so that the axial pivot pin forms an appropriate angle to the riding surface 25, which can be the same as the otherwise flared portion 31 of the skateboard deck 20. In addition, a riser (not shown) can be placed between the skateboard deck 20 and truck 30 to alter this angle and thereby the turning characteristics of the skateboard 10.

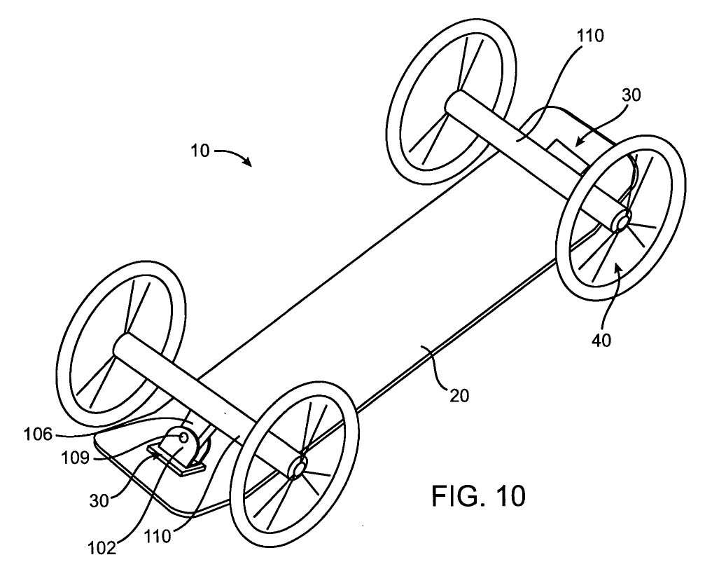

FIG. 10 shows a perspective view of the skateboard of FIG. 9, including the mounting configuration as shown in FIGS. 5 and 6. As shown in FIG. 10, the trucks 30 are mounted onto the upper surface 21 of the skateboard deck 20. The upper surface 21 is configured to provide a surface for the user of the skateboard 10. The lower surface 23 or underside of the skateboard deck 20 faces the ground surface 25. As a result of the truck 30 being mounted on the upper surface 21 of the skateboard deck 20, the trucks 30 are rotated 180 degrees from the configuration as shown in FIG. 1, wherein the trucks 30 are mounted on the lower surface of the skateboard deck 20.

It can be appreciated that the truck assembly 30 as shown in FIGS. 1-10 can be further equipped with an integrated or distinct actuating element as disclosed in U.S. patent application Ser. No. 10/980,626, filed on Nov. 2, 2004, which is incorporated herein in its entirety. The actuating element transfers lateral or transverse forces and displacements, directed roughly perpendicular to the longitudinal axis of the skateboard deck to which the truck is mounted, into enhanced turning geometries on the truck and/or skateboard braking capacity. Alternatively, the truck assembly 30 can be equipped with an integrated or attachable actuating element, which transfers lateral or transverse forces and displacements, directed roughly perpendicular to the longitudinal axis of the skateboard deck 20 to which the truck assembly is mounted, into enhanced turning geometries on the truck assembly 30 and/or skateboard braking capacity.

Although the deck 20 has been shown to be a skateboard deck, it can be appreciated that the deck 20 can be a platform such as a plain deck for moving furniture and other items, or an in-line skate.

While the invention has been described with reference to the preferred embodiments described above, it will be appreciated that the configuration of this invention can be varied and that the scope of this invention is defined by the following claims.

1. A skateboard comprising:
a skateboard deck having an upper surface and a lower surface, the upper surface configured to receive at least one foot of a skater and the lower surface facing a riding surface; and
a pair of trucks mounted on the upper surface of the skateboard deck.

2. The skateboard of claim 1, wherein each of the trucks comprise at least one axle, wherein the at least one axle extends beyond an outer edge of the skateboard deck.

3. The skateboard of claim 1, further comprising at least one wheel attached to each of the trucks.

4. The skateboard of claim 3, wherein the at least one wheel has an outer radius, wherein the outer radius of the at least one wheel is equal to at least a distance from the axle to the riding ground.

5. The skateboard of claim 1, wherein each of the trucks comprise a pair of axle extensions, wherein the axle extensions protrude laterally from a truck hanger upon which the at least one skateboard wheel is attachable.

6. The skateboard of claim 1, wherein the trucks are mounted on each end of the skateboard deck at an angle relative to the riding surface.

7. The skateboard of claim 1, wherein the skateboard deck has an outer portion positioned on at least one end of the skateboard deck, wherein the outer portion is at an angle relative to the riding surface and the trucks are mounted on the outer portion of the skateboard deck.

8. The skateboard of claim 1, wherein the trucks comprise a kingpin and a hanger, the trucks are mounted onto the upper surface of the skateboard deck, and wherein the hangers face inward towards each other and the kingpins face outward.

9. The skateboard of claim 1, wherein the trucks are rotated approximately 180 degrees from a truck assembly mounted on the lower surface of the skateboard deck.

10. A skateboard comprising:
a skateboard deck having an upper surface and a lower surface, the upper surface configured to receive at least one foot of a skater and the lower surface facing a riding surface;
a pair of trucks mounted on the upper surface of the skateboard deck, wherein each of the trucks comprise at least one axle, wherein the at least one axle extends beyond an outer edge of the skateboard deck; and
at least one wheel attached to the at least one axle.

11. The skateboard of claim 10, wherein the at least one wheel has an outer radius, wherein the outer radius of the at least one wheel is equal to at least a distance from the axle to the riding ground.

12. The skateboard of claim 10, wherein each of the trucks comprise a pair of axle extensions, wherein the axle extensions protrude laterally from a truck hanger upon which the at least one skateboard wheel is attachable.

13. The skateboard of claim 10, wherein the trucks are mounted on each end of the skateboard deck at an angle relative to the riding surface.

14. The skateboard of claim 10, wherein the skateboard deck has an outer portion positioned on at least one end of the skateboard deck, wherein the outer portion is at an angle relative to the riding surface and the trucks are mounted on the outer portion of the skateboard deck.

15. The skateboard of claim 10, wherein the trucks comprise a kingpin and a hanger, the trucks are mounted onto the upper surface of the skateboard deck, and wherein the hangers face inward towards each other and the kingpins face outward.

16. The skateboard of claim 10, wherein the trucks are rotated approximately 180 degrees from a truck assembly mounted on the lower surface of the skateboard deck.

17. A method of mounting a truck to a platform comprising:
providing a platform having an upper surface and a lower surface, the upper surface configured to receive a skater; and
mounting a truck configured to receive a pair of wheels on the upper surface of the platform.

18. The method of claim 17, further comprising attaching at least one wheel to the truck.

19. The method of claim 18, wherein the at least one wheel has an outer radius, wherein the outer radius of the at least one wheel is equal to at least a distance from the axle to the riding ground.

20. The method of claim 17, wherein the trucks comprise a kingpin and a hanger, wherein the trucks are mounted onto the upper surface of the skateboard deck, wherein the hangers face inward towards each other and the kingpins face outward.

21. The method of claim 17, further comprising rotating the trucks approximately 180 degrees from a truck mounted on the lower surface of the skateboard deck.
